(19) United States
(12) Patent Application Publication
(10) Pub. No.: US 2026/0310400 A1
(43) Pub. Date: Oct. 8, 2026

(54) CONTROL DEVICE, CONTROL METHOD, AND PROGRAM

(71) Applicant: NTT, Inc., Tokyo (JP)

(72) Inventors: Hironobu CHIBA, Tokyo (JP); Hiroaki ITO, Tokyo (JP); Kenichi NOGUCHI, Tokyo (JP); Tatsuya KAKO, Tokyo (JP)

(73) Assignee: NTT, Inc., Tokyo (JP)

(21) Appl. No.: 18/877,482

(22) PCT Filed: Jun. 27, 2022
(86) PCT No.: PCT/JP2022/025578

§ 371 Date: Dec. 20, 2024

(51) Int. Cl. G06F 3/16

(52) U.S. Cl. CPC G06F 3/165

(57) ABSTRACT

First control processing of changing a first acoustic signal such that a user is able to easily listen to a second acoustic signal in response to the second acoustic signal that is different from the first acoustic signal or a notification related to the second acoustic signal in a case where the user who is listening to the first acoustic signal is not in a concentration state or in a case where a degree of concentration of the user is lower than a first reference and second control processing of not performing the first control processing in a case where the user is in the concentration state or in a case where the degree of concentration is equal to or greater than the first reference are performed.

### TECHNICAL FIELD

The present invention relates to a technology for controlling reproduction of an acoustic signal.

### BACKGROUND ART

Acoustic signal output devices of a type that does not completely block the ear canals, such as open-ear-type (open-type) earphones and headphones, are known. Users who wear such an acoustic signal output device can listen to reproduced sound of their preference, such as music, in a state where they can hear surrounding sound.

However, even in a case where a user uses such an acoustic signal output device, there is a concern that the user is not aware of someone in the surroundings calling or a notification from a terminal device such as a smartphone and there may be a problem in communication with others if the volume of the reproduced sound is large. On the other hand, there may also be a case where a user intentionally listens to reproduced sound with a large volume in order to prevent his/her concentration state from being interrupted.

In this regard, Non Patent Literature 1 discloses a technology in which reproduced sound is automatically paused or muted when a user who is listening to the reproduced sound through headphones makes a speaking sound. Also, Patent Literature 1 discloses a technology in which an action of a user is estimated on the basis of a detection result of a sensor or the like and a maximum allowable volume of reproduced sound is controlled on the basis of the estimation result.

### CITATION LIST

### Patent Literature

Patent Literature 1: JP 2021-052262 A

### Non Patent Literature

Non Patent Literature 1: Speaking with someone while wearing the headphones (Speak-to-Chat) ; [online], Sony Corporation [retrieved June 1, 2022], the Internet <https://helpguide.sony.net/mdr/hpc/v1/ja/contents/TP0002935777.html>

### SUMMARY OF INVENTION

### Technical Problem

However, according to the technology of Non Patent Literature 1, the reproduced sound is not controlled as long as the user himself/herself does not make a speaking sound, and there is a concern that the user may have a problem in communication with others when they are not aware of a calling voice, a calling sound, a notification sound, or the like. Also, according to the technology in Patent Literature 1, the maximum allowable volume of the reproduced sound is controlled even in a case where the user intentionally listens to the reproduced sound with a large volume in order to prevent a concentration state from being interrupted.

Such problems are common not only to a case where the user is listening to reproduced sound with an acoustic signal output device of the type that does not block the ear canals but also to a case where a user who is listening to a first acoustic signal is in an environment where the user can also listen to a second acoustic signal that is different from the first acoustic signal.

In view of such a point, the present invention provides a technology that makes it easy for a user to communicate with others when the user is not concentrating and to maintain a concentration state when the user is concentrating in an environment where the user who is listening to a first acoustic signal can also listen to a second acoustic signal that is different from the first acoustic signal.

### Solution to Problem

First control processing of changing a first acoustic signal such that a user is able to easily listen to a second acoustic signal in response to the second acoustic signal that is different from the first acoustic signal or a notification related to the second acoustic signal in a case where the user who is listening to the first acoustic signal is not in a concentration state or in a case where a degree of concentration of the user is lower than a first reference and second control processing of not performing the first control processing in a case where the user is in the concentration state or in a case where the degree of concentration is equal to or greater than the first reference are performed.

### Advantageous Effects of Invention

This makes it easy for a user to communicate with others when the user is not concentrating and to maintain a concentration state when the user is concentrating in an environment where the user who is listening to a first acoustic signal can also listen to a second acoustic signal that is different from the first acoustic signal.

### BRIEF DESCRIPTION OF DRAWINGS

FIG. 1 is a diagram for illustrating, as an example, a configuration of an acoustic signal reproduction system according to an embodiment.

FIG. 2 is a flow diagram for illustrating, as an example, a control method according to the embodiment.

FIG. 3 is a diagram for illustrating, as an example, the configuration of the acoustic signal reproduction system according to the embodiment.

FIG. 4 is a block diagram for illustrating, as an example, a hardware configuration of a control device according to the embodiment.

### DESCRIPTION OF EMBODIMENTS

Hereinafter, an embodiment of the present invention will be described with reference to the drawings.

### First Embodiment

### Configuration

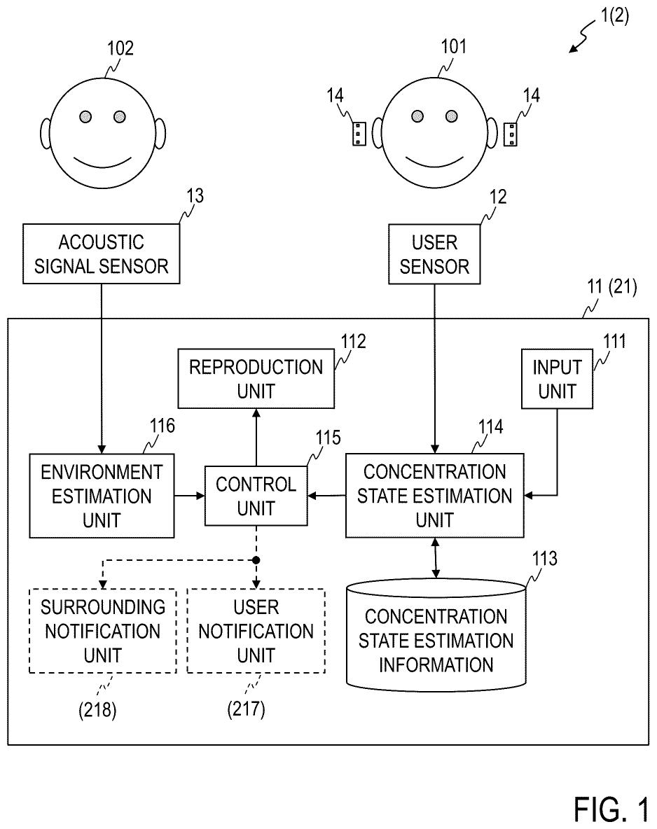

As illustrated in FIG. 1, an acoustic signal reproduction system 1 according to a first embodiment includes a control device 11, a user sensor 12, an acoustic signal sensor 13, and an acoustic signal output device 14.

The control device 11 includes an input unit 111, a reproduction unit 112, a storage unit 113, a concentration state estimation unit 114, a control unit 115, and an environment estimation unit 116.

The user sensor 12 is a sensor that detects a state of a user 101. The user sensor 12 includes, for example, at least any of a biological signal sensor that detects a biological signal of the user 101, an acceleration information sensor that detects a posture, a motion, a direction, or the like of the user 101, and a position sensor that detects the position of the user 101. Examples of the biological signal sensor include a sensor that detects a pulse or a heart rate of the user 101, a sensor that detects brain waves, and a sensor that detects eyeball movement. Examples of the acceleration information sensor include an acceleration sensor, an angular speed sensor, a geomagnetic sensor, and a nine-axis sensor. Examples of the position sensor include a geomagnetic sensor, a camera, a capacitance sensor, an ultrasonic sensor, and a potentiometer.

The acoustic signal sensor 13 is a microphone, a volume sensor, or the like that detects an acoustic signal AC2 (second acoustic signal) in the surroundings.

The acoustic signal output device 14 is, for example, earphones, headphones, a neck speaker, a bone conduction speaker, or another speaker that outputs an acoustic signal AC1 (first acoustic signal). The acoustic signal output device 14 may be of a type that does not completely block the ear canals of the user 101 or may be of a type that completely blocks the ear canals of the user 101.

### Pre-Processing

In pre-processing, the storage unit 113 stores “concentration state estimation information” for estimating a concentration state of the user 101 from “input information”.

The “input information” may be “detection information” detected by the user sensor 12 or a function value thereof, may be the “detection information” and “other information” related to the concentration state of the user 101 or a function value thereof, or may be the “other information” or a function value thereof, for example. The “other information” is, for example, information indicating content of a task of the user 101, information indicating a task duration of the user 101, information indicating a clock time at which the user 101 has performed a task, information indicating an intention of the user 101 (an intention such as “wants to concentrate”, “able to communicate”, “wants to turn off notification”, and “wants to turn on notifications”), and the like. The “concentration state estimation information” may be information for obtaining the “information indicating whether or not the user 101 is in the concentration state” with respect to the “input information” or may be information for obtaining “information indicating a degree of concentration” of the user 101 with respect to the “input information”, for example. Note that the higher degree of concentration corresponds to a state of more concentration and the lower degree of concentration corresponds to a state of less concentration. The “concentration state estimation information” may be a table with which the “input information” and the “information indicating whether or not the user 101 is in the concentration state” are associated, may be a table with which the “input information” and the “information indicating a degree of concentration” are associated, or may be a threshold value of “input information” for determining “whether or not the user 101 is in the concentration state”, for example. These tables and threshold value are determined in advance on the basis of, for example, past “detection information”, a past task log, a duration of a past task, and a clock time at which the past task was done. Additionally, “concentration state estimation information” may be an estimation model for outputting the “information indicating whether or not the user 101 is in the concentration state” with respect to the “input information” or may be an estimation model for outputting the “information indicating a degree of concentration” with respect to the “input information”. Examples of the estimation model include a model based on deep learning, a hidden Markov model, and a support vector machine (SVM). These models are obtained, for example, by machine learning using a learning model. An example of the learning model is supervised learning data or the like in which “input information for learning” (past detection information, a past task log, a duration of a past task, a clock time at which the past task was performed, and the like) is associated with a label representing “whether or not the user 101 is in the concentration state”, “the degree of concentration”, or the like. The method of estimating the concentration state is not limited, and a known estimation method such as a technology disclosed in JP 2014-158600 A or the like may be used.

### Processing

The reproduction unit 112 of the control device 11 (FIG. 1) outputs a reproduction signal representing an acoustic signal AC1 (first acoustic signal) that the user 101 listens to under control of the control unit 115. The acoustic signal AC1 is, for example, music, sound, environmental sound, or other acoustic content. The reproduction signal is transmitted to the acoustic signal output device 14 in a wired or wireless manner, and the acoustic signal output device 14 outputs the acoustic signal AC1 on the basis of the transmitted reproduction signal. The user 101 listens to the acoustic signal AC1 output from the acoustic signal output device 14.

The user sensor 12 detects the state of the user 101 and transmits the detected “detection information” to the concentration state estimation unit 114. In a case where the user sensor 12 includes a biometric signal sensor, the “detection information” includes information indicating a biometric signal of the user 101. In a case where the user sensor 12 includes an acceleration information sensor, the “detection information” includes information indicating the posture, motion, orientation, and the like of the user 101 such as acceleration and angular acceleration of the user 101. In a case where the user sensor 12 includes a position sensor, the “detection information” includes information indicating the position of the user 101. In a case where “other information” regarding the concentration state of the user 101 is input from the input unit 111, the “other information” is transmitted to the concentration state estimation unit 114.

The concentration state estimation unit 114 uses the “input information” of the user 101 including at least one of the “detection information” and the “other information” and the “concentration state estimation information” extracted from the storage unit 113 to obtain and output the “information indicating whether or not the user 101 is in the concentration state” or the “information indicating the degree of concentration” of the user 101. In a case where the “concentration state estimation information” is a table in which the “input information” and the “information indicating whether or not the user 101 is in the concentration state” or the “information indicating the degree of concentration” are associated, for example, the concentration state estimation unit 114 obtains and outputs the “information indicating whether or not the user 101 is in the concentration state” or the “information indicating the degree of concentration” corresponding to the “input information” of the user 101. For example, in a case where the “concentration state estimation information” is a threshold value of the “input information” for determining “whether or not the user 101 is in the concentration state”, the concentration state estimation unit 114 performs threshold determination of the “input value” of the user 101 and obtains and outputs the “information indicating whether or not the user 101 is in the concentration state”. In a case where the “concentration state estimation information” is an estimation model of outputting the “information indicating whether or not the user 101 is in the concentration state” or the “information indicating the degree of concentration” with respect to the “input information”, for example, the concentration state estimation unit 114 obtains and outputs the “information indicating whether or not the user 101 is in the concentration state” or the “information indicating the degree of concentration” corresponding to the “input information” by using the estimation model. In a case where the “other information” includes information indicating an intention of the user 101, the concentration state estimation unit 114 may obtain and output the “information indicating whether or not the user 101 is in the concentration state” by placing priority on the intention of the user 101. In a case where the “other information” represents an intention such as “desire to concentrate” or “desire to turn off a notification”, for example, the concentration state estimation unit 114 may output the “information indicating that the user 101 is in the concentration state” as the “information indicating whether or not the user 101 is in the concentration state”. In a case where the “other information” represents an intention such as “possible to communicate” or “desire to turn on a notification”, for example, the concentration state estimation unit 114 may output the “information indicating that the user 101 is not in the concentration state” as the “information indicating whether or not the user 101 is in the concentration state”. The information indicating the intention of the user 101 included in the “other information” is stored in the storage unit 113, and the concentration state estimation unit 114 may obtain and output the “information indicating whether or not the user 101 is in the concentration state” as described above on the basis of the information indicating the intention stored in the storage unit 113 until the intention of the user 101 is updated. The “Information indicating whether or not the user 101 is in the concentration state” or the “information indicating the degree of concentration” is transmitted to the control unit 115.

The acoustic signal sensor 13 detects the surrounding acoustic signal AC2 (second acoustic signal) and transmits information indicating the acoustic signal AC2 to the environment estimation unit 116. The environment estimation unit 116 transmits, to the control unit 115, “acoustic detection information” representing the result of detecting the surrounding acoustic signal by using the input information indicating the acoustic signal AC2. The acoustic detection information is, for example, information indicating whether or not the user 102 has made an utterance in the surroundings or information indicating loudness of the surrounding sound.

The “information indicating whether or not the user 101 is in the concentration state” or the “information indicating the degree of concentration” transmitted from the concentration state estimation unit 114 and the “acoustic detection information” transmitted from the environment estimation unit 116 are input to the control unit 115 in real time. The control unit 115 determines whether or not the user 101 who is listening to the acoustic signal AC1 is in the concentration state using the “information indicating whether or not the user 101 is in the concentration state” or determines whether or not the degree of concentration of the user 101 is equal to or greater than a reference TH1 (first reference) using the “information indicating the degree of concentration”. Here, in a case where the user 101 is not in the concentration state or in a case where the degree of concentration of the user 101 is less than the reference TH1 (first reference), the control unit 115 performs control processing CON1 (first control processing) of changing the acoustic signal AC1 such that the user 101 can easily listen to the acoustic signal AC2 in accordance with the acoustic signal AC2 (the second acoustic signal that is different from the first acoustic signal) in the surroundings of the user 101 represented by the “acoustic detection information”. This processing is automatically performed. In this manner, the user 101 can be easily aware of calling from a user 102 and can easily communicate with others when the user 101 is not concentrating. On the other hand, control processing CON2 (second control processing) is performed in a case where the user 101 is in the concentration state or in a case where the degree of concentration is equal to or greater than the reference TH1. The control processing CON2 (second control processing) is processing of not performing the control processing CON1 (first control processing). In this manner, the user 101 can easily maintain the concentration state when the user 101 is concentrating. Hereinafter, specific examples of the control processing CON1 (first control processing) and the control processing CON2 (second control processing) will be described.

Specific example of control processing CON1 (first control processing):

The control processing CON1 (first control processing) includes, for example, processing of changing the acoustic signal AC1 (first acoustic signal) such that the user 101 can easily listen to the acoustic signal AC2 (second acoustic signal) in a case where the magnitude of the amplitude of the acoustic signal AC2 (second acoustic signal) is equal to or greater than a reference TH2 (second reference) or in a case where the acoustic signal AC2 (second acoustic signal) is detected. An example of this processing is processing of attenuating the amplitude of the acoustic signal AC1 (first acoustic signal). Alternatively, the phase or the waveform of the acoustic signal AC1 (first acoustic signal) may be changed such that the user 101 can easily listen to the acoustic signal AC2 (second acoustic signal). In this manner, the user 101 can be easily aware of calling or the like from the user 102. On the other hand, such processing of changing the acoustic signal AC1 (first acoustic signal) (the processing of changing the first acoustic signal such that the user can easily listen to the second acoustic signal) is not executed in a case where the magnitude of the amplitude of the acoustic signal AC2 (second acoustic signal) is less than the reference TH2 (second reference) or in a case where the acoustic signal AC2 (second acoustic signal) has not been detected. It is thus possible to prevent the acoustic signal AC1 from changing in accordance with the concentration state of the user 101 regardless of no calling or the like from the user 102.

Specific example of control processing CON2 (second control processing):

In the control processing CON2 (second control processing), the processing of changing the acoustic signal AC1 such that the user 101 can easily listen to the acoustic signal AC2 is not executed. For example, the amplitude of the acoustic signal AC1 is not automatically attenuated, and the phase or the waveform of the acoustic signal AC1 is not changed, in the control processing CON2. For example, the control processing CON2 may be control of performing nothing. In this manner, it is possible to maintain the concentration state of the user 101 even if there is a calling from the surroundings or the surroundings are noisy when the user 101 is listening to the acoustic signal AC1 with a large volume in order to maintain the concentration state.

Additionally, the control processing CON2 may include processing of changing the acoustic signal AC1 (first acoustic signal) such that it becomes difficult for the user 101 to listen to the acoustic signal AC2 (second acoustic signal). For example, the magnitude of each frequency component of the acoustic signal AC1 may be changed, the phase of the acoustic signal AC1 may be changed, or the acoustic signal AC1 may be changed to mask the acoustic signal AC2, such that it becomes difficult for the user 101 to listen to the acoustic signal AC2. For example, an acoustic signal obtained by adding an antiphase acoustic signal of the acoustic signal AC2 or an acoustic signal that is approximate to the antiphase acoustic signal to the original acoustic signal AC1 may be used as a new acoustic signal AC1. In this manner, it is possible to further maintain the concentration state of the user 101 even if there is a calling from the surroundings or the surroundings are noisy.

Specific example of control processing of control unit 115:

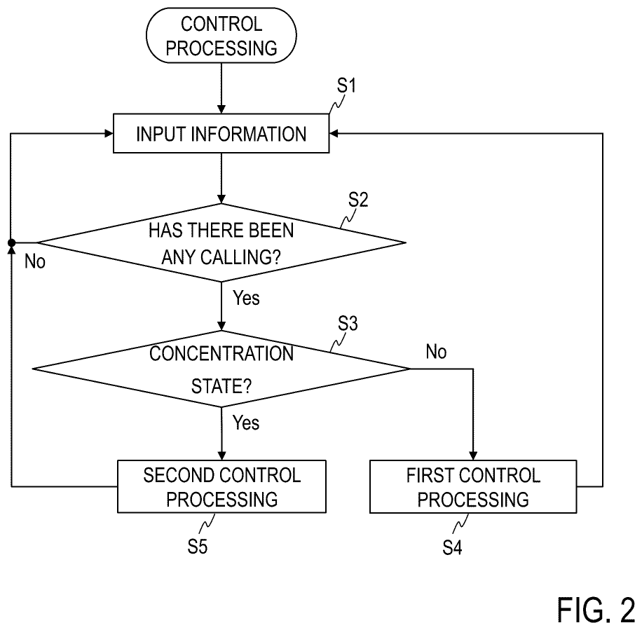

A specific example of control processing performed by the control unit 115 will be described with reference to FIG. 2.

The control unit 115 receives the “information indicating whether or not the user 101 is in the concentration state” or the “information indicating the degree of concentration” transmitted from the concentration state estimation unit 114 and the “acoustic detection information” transmitted from the environment estimation unit 116 (Step S1). The control unit 115 determines whether or not there is a calling by using the acoustic detection information. For example, the control unit 115 determines that there has been a calling in a case where the magnitude of the amplitude of the acoustic signal AC2 is equal to or greater than the reference TH2 or in a case where the acoustic signal AC2 is detected, and determines that there has been no calling in the other cases (Step S2). Here, the processing returns to Step S1 in a case where it is determined that there has been no calling. On the other hand, in a case where it is determined that there has been a calling, the control unit 115 determines whether or not the user 101 is in the concentration state or the degree of concentration of the user 101 by using the “information indicating whether or not the user 101 is in the concentration state” or the “information indicating the degree of concentration” (Step S3). Here, in the case where the user 101 is not in the concentration state or in the case where the degree of concentration of the user 101 is less than the reference TH1 (first reference), the control unit 115 performs the control processing CON1 (first control processing) (Step S4) and then returns the processing to Step S1. On the other hand, in the case where the user 101 is in the concentration state or in the case where the degree of concentration is equal to or greater than the reference TH1, the control unit 115 performs the control processing CON2 (second control processing) (Step S5) and then returns the processing to Step S1.

### Features of Present Embodiment

As described above, the acoustic signal AC1 is controlled on the basis of the concentration state or the degree of concentration of the user 101 who is listening to the acoustic signal AC1 and the acoustic signal AC2 that is different from the acoustic signal AC1 in the present embodiment. In this manner, the user 101 can easily communicate with others when the user 101 is not concentrating and can easily maintain the concentration state when the user is concentrating.

### Second Embodiment

A second embodiment is a modification example of the first embodiment, and a notification is further provided to a user 101 and another user 102 on the basis of a concentration state and a degree of concentration of the user 101 who is listening to an acoustic signal AC1 and an acoustic signal AC2 that is different from the acoustic signal AC1. In the description below, differences from the first embodiment will be mainly explained, and the components that have already been described will be denoted by the same reference numerals to simplify the explanation.

### Configuration

As illustrated in FIG. 1, an acoustic signal reproduction system 2 according to the second embodiment includes a control device 21, a user sensor 12, an acoustic signal sensor 13, and an acoustic signal output device 14. The control device 21 includes an input unit 111, a reproduction unit 112, a storage unit 113, a concentration state estimation unit 114, a control unit 115, an environment estimation unit 116, a user notification unit 217, and a surrounding notification unit 218.

### Pre-Processing

This is the same as that in the first embodiment.

### Processing

Differences from the first embodiment are in control processing CON1 (first control processing) and control processing CON2 (second control processing). The control processing CON1 in the second embodiment includes processing of presenting notification information N1 (first notification information) to the user 101 in a case where the magnitude of an amplitude of the acoustic signal AC2 (second acoustic signal) is equal to or greater than a reference TH2 (second reference) or in a case where the acoustic signal AC2 (second acoustic signal) is detected. In the control processing CON1, the control unit 115 further provides, to the user notification unit 217, an instruction to output the notification information N1, and the user notification unit 217 performs the processing of presenting the notification information N1 to the user 101. This processing is processing for outputting the notification information N1 from the acoustic signal output device 14, the control device 11, or another device (a smartphone, for example), for example, to the user 101. The notification information N1 may be auditory information (a notification sound, a notification voice, or the like, for example), a visual information (LED light emission, image display, a change in lighting, a notification message, or the like, for example), a tactile information (vibration or the like, for example), or a combination of at least some of them. Presenting of the notification information NI to the user 101 enables the user 101 to be aware of the calling from another person and to more smoothly communicate with others.

Also, the control processing CON2 in the second embodiment includes processing of presenting notification information N2 (second notification information) to a person other than the user 101 (a user 102, for example). In the control processing CON2, the control unit 115 further provides, to the surrounding notification unit 218, an instruction to output the notification information N2, and the surrounding notification unit 218 performs the processing of presenting the notification information N2 to a person other than the user 101. This processing is processing for outputting the notification information N2 from the acoustic signal output device 14, the control device 11, or another device (a smartphone, for example), for example, to the person other than the user 101. The notification information N2 may be auditory information (a notification sound, a notification voice, or the like, for example), a visual information (LED light emission, image display, a change in lighting, a notification message, or the like, for example), a tactile information (vibration or the like, for example), or a combination of at least some of them. In this manner, it is possible to let the person other than the user 102 know that the user 101 is in the concentration state, and the user 101 can maintain the concentration state without being interrupted by others.

Alternatively, the control processing CON1 may include the aforementioned processing for presenting the notification information N1, and the control processing CON2 may not include the aforementioned processing for presenting the notification information N2. Alternatively, the control processing CON1 may not include the aforementioned processing for presenting the notification information N1, and the control processing CON2 may include the aforementioned processing for presenting the notification information N2.

### Features of Present Embodiment

As described above, presenting the notification information N1 to the user 101 when the user 101 is not concentrating enables the user 101 to further easily communicate with others. Additionally, presenting the notification information N2 to a person other than the user 101 when the user 101 is concentrating enables the user 101 to further maintain the concentration state.

### Third Embodiment

In the first and second embodiments, a situation in which the user 101 communicates with the user 102 in the surroundings has been assumed. However, a situation in which the user 101 communicates with others via a communication device such as a smartphone can also be assumed. Such a situation is assumed in the present embodiment.

### Configuration

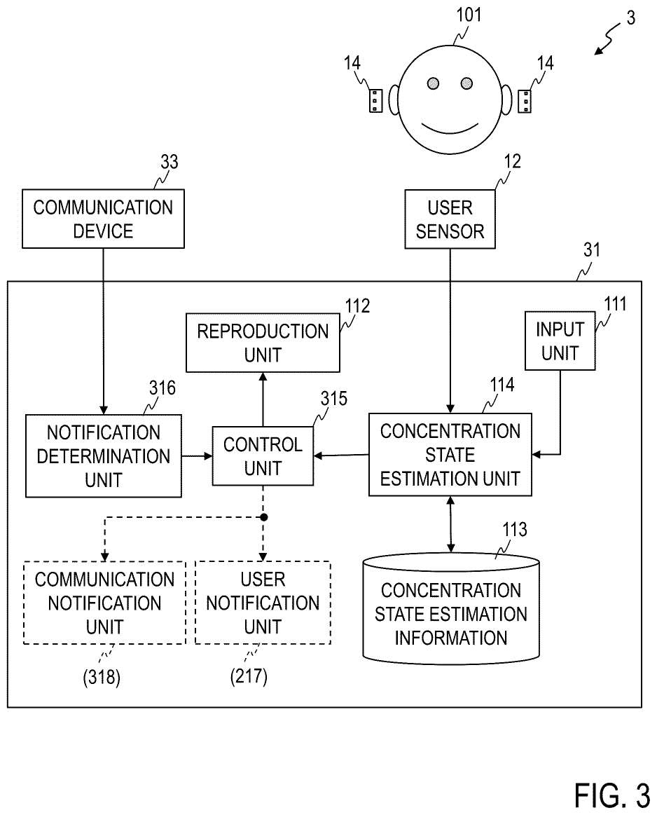

As illustrated in FIG. 3, an acoustic signal reproduction system 3 according to a third embodiment includes a control device 31, a user sensor 12, a communication device 33, and an acoustic signal output device 14. The control device 31 includes an input unit 111, a reproduction unit 112, a storage unit 113, a concentration state estimation unit 114, a control unit 315, and a notification determination unit 316. The control device 31 may further include a user notification unit 217 and a communication notification unit 318.

### Pre-Processing

This is the same as that in the first embodiment.

### Processing

A difference between the first and second embodiments is that the communication device 33 such as a smartphone instead of the acoustic signal sensor 13 sends a notification such as an incoming call (a notification related to the second acoustic signal) to the notification determination unit 316 and the notification determination unit 316 transmits the “notification detection information” indicating whether or not there has been a notification to the communication device 33 to the control unit 315 on the basis of the input notification.

“Information indicating whether or not the user 101 is in the concentration state” or “information indicating the degree of concentration” transmitted from the concentration state estimation unit 114 and “notification detection information” transmitted from the notification determination unit 316 are input to the control unit 315 in real time as described above. The control unit 315 determines whether or not the user 101 who is listening to the acoustic signal AC1 is in the concentration state by using the “information indicating whether or not the user 101 is in the concentration state” or determines whether or not the degree of concentration of the user 101 is equal to or greater than a reference TH1 (first reference) by using the “information indicating the degree of concentration”. Here, in a case where the user 101 is not in the concentration state or in a case where the degree of concentration of the user 101 is less than the reference TH1 (first reference), the control unit 315 performs the control processing CON1 (first control processing) of changing the acoustic signal AC1 such that the user 101 can easily listen to the acoustic signal AC2 (second acoustic signal) output from the communication device 33 in response to the notification indicated by the “notification detection information” (the notification related to the second acoustic signal). This processing is automatically performed. In this manner, the user 101 can be easily aware of the notification from the communication device 33 and can easily communicate with others via the communication device 33 when the user 101 is not concentrating. On the other hand, in a case where the user 101 is in the concentration state or in a case where the degree of concentration is equal to or greater than the reference TH1, the control processing CON2 (second control processing) of not performing the control processing CON1 (first control processing) is performed. In this manner, the user 101 can easily maintain the concentration state when the user 101 is concentrating. Hereinafter, specific examples of the control processing CON1 (first control processing) and the control processing CON2 (second control processing) will be described.

Specific example of control processing CON1 (first control processing):

The control processing CON1 (first control processing) includes processing of changing the acoustic signal AC1 (first acoustic signal) such that the user 101 can easily listen to the acoustic signal AC2 (second acoustic signal) output from the communication device 33 in a case where a notification such as an incoming call (a notification related to the second acoustic signal) has arrived at the communication device 33, for example. An example of this processing is processing of attenuating the amplitude of the acoustic signal AC1 (first acoustic signal). In this manner, the user 101 can be easily aware of the notification from the communication device 33. On the other hand, in a case where no notification such as an incoming call (a notification related to the second acoustic signal) has arrived at the communication device 33, the processing of changing the acoustic signal AC1 (first acoustic signal) such that the user 101 can easily listen to the acoustic signal AC2 (second acoustic signal) is not executed. It is thus possible to prevent the acoustic signal AC1 from changing in accordance with the concentration state of the user 101 regardless of no incoming call or the like arriving at the communication device 33.

In the control processing CON1, the control unit 315 may further provide, to the user notification unit 217, an instruction to output the notification information N1, and the user notification unit 217 may perform the processing of presenting the notification information N1 to the user 101. The specific example is as described above in the second embodiment.

Specific example of control processing CON2 (second control processing):

In the control processing CON2 (second control processing), the processing of changing the acoustic signal AC1 such that the user 101 can easily listen to the acoustic signal AC2 is not executed. For example, the amplitude of the acoustic signal AC1 is not automatically attenuated, and the phase or the waveform of the acoustic signal AC1 is not changed, in the control processing CON2. In this manner, it is possible to maintain the concentration state of the user 101 even if an incoming call or the like has arrived at the communication device 33 when the user 101 is listening to the acoustic signal AC1 with a large volume in order to maintain the concentration state.

In the control processing CON2, the communication device 33 may present the notification information N2 (second notification information) to a communication counterpart. In this case, it is only necessary for the control unit 315 to further provide, to the communication notification unit 318, an instruction to transmit the notification information N2 to the communication counterpart, and it is only necessary for the communication notification unit 318 to transmit the notification information N2 to the communication device 33 and to provide an instruction to transmit the notification information N2 to the communication counterpart. The notification information N2 may be auditory information (a notification sound, a notification voice, or the like, for example), a visual information (a notification message or the like, for example), a tactile information (vibration or the like, for example), or a combination of at least some of them. In this manner, it is possible to let the communication counterpart know that the user 101 is in the concentration state, and the user 101 can maintain the concentration state without being interrupted by others.

The other processing of the control unit 315 is the same as that of the control unit 115.

### Features of Present Embodiment

As described above, the acoustic signal AC1 is controlled on the basis of the concentration state or the degree of concentration of the user 101 who is listening to the acoustic signal AC1 and the notification related to the acoustic signal AC2 that is different from the acoustic signal AC1 in the present embodiment. In this manner, the user 101 can easily communicate with others when the user 101 is not concentrating and can easily maintain the concentration state when the user is concentrating.

### Hardware Configuration

The control device 11, 21, or 31 in each embodiment is a device configured by a general-purpose or dedicated computer executing a predetermined program, the computer including a processor (a hardware processor) such as a central processing unit (CPU), and a memory such as a random access memory (RAM) and a read only memory (ROM), for example. In other words, the control device 11, 21, or 31 in each embodiment includes processing circuitry configured to implement each unit included therein, for example. This computer may include one processor and memory, or may include a plurality of processors and memories. The program may be installed into the computer, or may be recorded in a ROM or the like in advance. In addition, some or all processing units may be configured using electronic circuitry that independently implements a processing function, instead of electronic circuitry that implements a functional configuration by reading a program like a CPU. Also, an electronic circuit forming one device may include a plurality of CPUs.

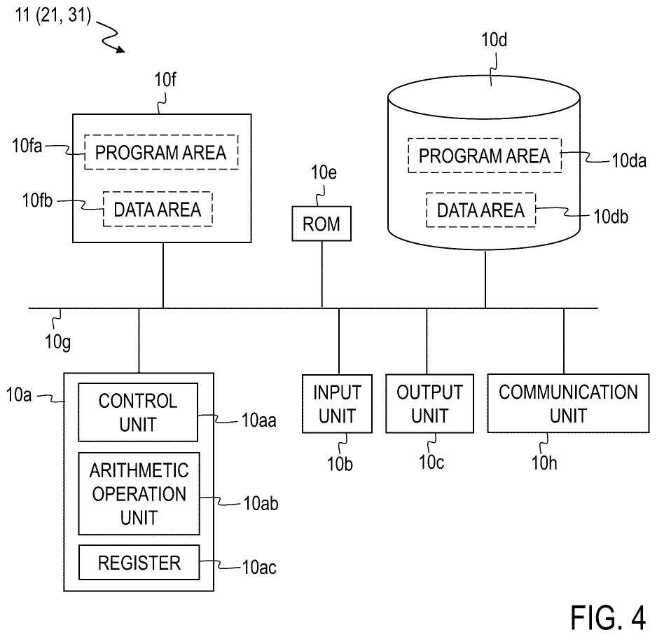

FIG. 4 is a block diagram illustrating, as an example, a hardware configuration of the control device 11, 21, or 31 in each embodiment. As illustrated as an example in FIG. 4, the control devices 11, 21, or 31 in this example include a central processing unit (CPU) 10a, an input unit 10b, an output unit 10c, a random access memory (RAM) 10d, a read only memory (ROM) 10e, an auxiliary storage device 10f, a communication unit 10h, and a bus 10g. The CPU 10a in this example includes a control unit 10aa, an arithmetic operation unit 10ab, and a register 10ac, and performs various arithmetic operations in accordance with various programs read into the register 10ac. Further, the input unit 10b is an input terminal, a keyboard, a mouse, a touch panel, or the like to which data is input. Further, the output unit 10c is an output terminal, a display, or the like from which data is output. The communication unit 10h is a LAN card or the like controlled by the CPU 10a that has read a predetermined program. The RAM 10d is a static random-access memory (SRAM), a dynamic random-access memory (DRAM), or the like, and includes a program area 10da in which a predetermined program is stored and a data area 10 db in which various kinds of data are stored. The auxiliary storage device 10f is a hard disk, a magneto-optical disc (MO), a semiconductor memory, or the like, for example, and includes a program area 10fa in which a predetermined program is stored and a data area 10fb in which various kinds of data are stored. Further, the bus 10g connects the CPU 10a, the input unit 10b, the output unit 10c, the RAM 10d, the ROM 10e, the communication unit 10h, and the auxiliary storage device 10f such that information can be exchanged therebetween. The CPU 10a writes, into the program area 10da of the RAM 10d, the program stored in the program area 10fa of the auxiliary storage device 10f in accordance with a read operating system (OS) program. Similarly, the CPU 10a writes, into the data area 10 db of the RAM 10d, the various kinds of data stored in the data area 10fb of the auxiliary storage device 10f. Addresses on the RAM 10d in which the program and the data have been written are stored into the register 10ac of the CPU 10a. The control unit 10aa of the CPU 10a sequentially reads these addresses stored in the register 10ac, reads the program and the data from the areas in the RAM 10d indicated by the read addresses, causes the arithmetic operation unit 10ab to sequentially execute arithmetic operations indicated by the program, and stores results of the arithmetic operations in the register 10ac. With such a configuration, the functional configurations of the control devices 11, 21, and 31 are realized.

The program described above can be recorded in a computer-readable recording medium. Examples of the computer-readable recording medium include a non-transitory recording medium. Examples of such a recording medium include a magnetic recording device, an optical disc, a magneto-optical recording medium, a semiconductor memory, and the like.

The program is distributed by selling, giving, or renting portable recording media such as DVDs or CD-ROMs recording the program thereon, for example. Furthermore, the program may be stored in a storage device of a server computer, and the program may be distributed by transferring the program from the server computer to another computer via a network. As described above, the computer executing such a program first stores a program recorded in a portable recording medium or a program transferred from the server computer temporarily into a storage device of the computer, for example. Then, at the time of executing processing, the computer reads the program stored in the storage device thereof and executes processing according to the read program. Also, in other modes of execution of the program, the computer may read the program directly from a portable recording medium and execute processing in accordance with the program, or alternatively, the computer may sequentially execute processing in accordance with a received program every time a program is transferred from the server computer to the computer. Moreover, the above-described processing may be executed by a so-called application service provider (ASP) type service that implements a processing function only by an execution instruction and result acquisition without transferring the program from a server computer to the computer. Note that the program in the present embodiment includes information used for processing by an electronic computer and equivalent to the program (data or the like that is not a direct command to the computer but has property that defines processing performed by the computer).

Although this device is formed with a computer executing a predetermined program in each embodiment, at least some of the processing contents may be implemented by hardware.

### Other Modified Examples

Note that the present invention is not limited to the above-described embodiments. The above various kinds of processing may be performed not only in a chronological manner in accordance with the description but also in parallel or individually in accordance with the processing ability of the device that performs the processing or as necessary. In addition, it is needless to say that appropriate modifications can be made without departing from the scope of the present invention.

### REFERENCE SIGNS LIST

1, 2, 3 Acoustic signal reproduction system
11, 21, 31 Control device
115, 315 Control unit

1. A control device comprising processing circuitry configured to
perform first control processing of changing a first acoustic signal such that a user is able to easily listen to a second acoustic signal in response to the second acoustic signal that is different from the first acoustic signal or a notification related to the second acoustic signal in a case where the user who is listening to the first acoustic signal is not in a concentration state or in a case where a degree of concentration of the user is lower than a first reference, and
perform second control processing of not performing the first control processing in a case where the user is in a concentration state or in a case where the degree of concentration is equal to or greater than the first reference.

2. The control device according to claim 1, wherein the first control processing includes processing of changing the first acoustic signal such that the user is able to easily listen to the second acoustic signal in a case where a magnitude of an amplitude of the second acoustic signal is equal to or greater than a second reference or in a case where the second acoustic signal is detected.

3. The control device according to claim 1, wherein the first control processing includes processing of attenuating an amplitude of the first acoustic signal in a case where a magnitude of an amplitude of the second acoustic signal is equal to or greater than a second reference or in a case where the second acoustic signal is detected.

4. The control device according to claim 1, wherein the first control processing includes processing of presenting first notification information to the user in a case where a magnitude of an amplitude of the second acoustic signal is equal to or greater than a second reference or in a case where the second acoustic signal is detected.

5. The control device according to claim 1, wherein the second control processing includes processing of changing the first acoustic signal such that it becomes difficult for the user to listen to the second acoustic signal.

6. The control device according to claim 1, wherein the second control processing includes processing of presenting second notification information to a person other than the user.

7. A control method performed by a control device comprising:
a first step of performing first control processing of changing a first acoustic signal such that a user is able to easily listen to a second acoustic signal in response to the second acoustic signal that is different from the first acoustic signal or a notification related to the second acoustic signal in a case where the user who is listening to the first acoustic signal is not in a concentration state or in a case where a degree of concentration of the user is lower than a first reference; and
a second step of performing second control processing of not performing the first control processing in a case where the user is in the concentration state or in a case where the degree of concentration is equal to or greater than the first reference.

8. A non-transitory computer-readable recording medium storing a program that causes a computer to function as the control device according to claim 1.
